(19) United States
(12) Patent Application Publication
(10) Pub. No.: US 2005/0068502 A1
(43) Pub. Date: Mar. 31, 2005

(54) Fan Cup

(76) Inventor: Doug Mau, Ringwood, NJ (US)

Correspondence Address: Mr. Doug Mau;Bear Mountain Management, 43 Bear Mountain Road, Ringwood, NJ, 07456, US

(21) Appl. No.: 10/671,121

(22) Filed: Sep. 25, 2003

(51) Int. Cl. G03B 21/00; F21V 33/00

(52) U.S. Cl. 353/31

(57) ABSTRACT

Illuminated novelty items are disclosed which utilize a self contained illuminated display pod positioned at an appropriate height in an inner housing to illuminate display information on the outer housing, for example on the semi-opaque or translucent sidewalls of an open ended container.

### FIELD OF THE INVENTION

The invention, the Fan Cup, is directed to illuminated novelty items, and more specifically to multi-use illuminated drinking vessels that utilize the sidewalls of the exterior, and molded interior pieces of the cup to display logos or icons.

### BACKGROUND OF THE INVENTION

Sports and entertainment merchandising is a multi billion dollar industry. It is a primary source of income for most kinds of sporting and entertainment events. Further expanding this market are the event or tour sponsors who utilize merchandise as “giveaways” to promote their brand at these events. Many of these events take place in a darkened setting whether it is in the confines of an indoor theatre or a nighttime event held at an amphitheatre or a sports stadium. The lighted novelty market is the fastest growing segment of this huge market. There is great demand for innovative novelties that clearly illuminate a team or star's logo or icon. The Fan Cup is a novel concept that can clearly illuminate any logo or icon.

One of the major attractions of sporting and entertainment events is their ability to get the fans interactively involved in the event. It is not uncommon to see sporting fans waving merchandise like a rally towel at a baseball game or concertgoers holding glow sticks aloft in celebration of the performance. Fans want to be involved and fans want to celebrate. The Fan Cup allows these fans a chance to celebrate the moment with a branded item that is clearly visible from a great distance in the dark. The item is easily illuminated at the proper moment and then is immediately ready for the next celebration. It is a user-friendly item from design to functionality. There is a major emerging market in the event and sports marketing for items that clearly illuminate a team or star's logo. The most successful items are those that easily allow fans to celebrate each moment with their respective team or star at a very affordable price. The Fan Cup clearly meets all of these needs.

### DESCRIPTION OF THE PRIOR ART

There are several patented lighted drinking vessels on the market today, including vessels that utilize the “glow” technology as described in U.S. Pat. No. 6,371,624. This is a single use item that once activated will illuminate for a specific period of time and then becomes spent or unusable again. Glow cups work on several different principles from a glow ring placed on the bottom of a cup (like the above referenced patent) to cups filled with the “glow” material that are activated by releasing the “glow” liquid. The limitations of glow cups in general are that they only work once, the glow colors are limited to a single color and the cups are unevenly lit.

Lighted drinking vessels such as that described in U.S. Pat. No. 5,575,553 that are battery powered LED devices. These devices generally work by affixing a base unit that contains the batteries and LED's to the bottom of the cup. Generally the LED's edge light the plastic cup in a way that illuminates the sides of the cup. This concept is very limiting to the end user on many levels. First of all edge lighting will only allow certain colors to be used in printing logos or icons on the cup. For instance black lettering on a cup utilizing Red LED's will become unreadable due to the edge lighting technique. It is not possible to use a full four-color print on an edge lit cup. Additionally these base lit cups require a great deal of manipulation in order to use them. The end user must turn the unit on and off. The user must remove the base of the cup in order to wash the cup. This makes use of the item laborious and time consuming. It also makes the item very expensive to manufacture.

Another vessel is described in U.S. Pat. No. 6,005,204. This item was originally designed as a display module for promotional items. The dome shaped interior base unit therefore is not designed specifically to cleanly illuminate the sidewalls of the cup.

The Fan Cup is designed to allow a full palate of print and LED colors to be used in creating the item. The Fan Cup is a multi-use item that triggers On/Off via a magnetic switch up to 1000 times before becoming spent. The fan cup is simple and easy to use. The Fan cup clearly displays full four color logos or icons. The Fan Cup is novel in that it does achieve all of the things its end user wants it to be in a way that no other patented item has ever been able to achieve.

It is therefore an object of this invention to provide a new and improved method for back light illumination of print or physical displays of images on or molded as part of drinking cups.

It is further an object of this invention to provide an illumination source that can be actuated by the user on demand without manually flipping or sliding the switch to actuate the device.

It is further an object of this invention to provide an illumination source that is a self-contained, element that is capable executing extended and varying pre-programmed lighting cues.

It is further an object of this invention to create a multi-use illuminated drinking cup that can be immediately washed with no other additional manipulation of the object other than to wash it.

It is further an object of this invention to provide a drinking vessel the clearly illuminates four color print process logos or icons in a darkened setting.

### SUMMARY OF THE INVENTION

The invention, broadly understood is an illuminated display item having an outer housing at least partly transparent to visible light and an inner housing at least partly transparent to visible light inserted into the outer housing. Inside the inner housing is a light emitting display pod including a power supply and a motion activated switch, so that the pod can be illuminated for a period of time when the display item is moved abruptly. To dispose the pod at an appropriate height in the display, a plunger is inserted into the inner housing to support the display pod. The pod is provided with circuitry to permit illumination of the display for a period of time, and is not in electrical contact with the plunger, the inner housing or the outer housing.

In a preferred embodiment, the display item is in the form of a cup with an open end. The inner housing which holds the pod is inserted into and mates with the container sidewalls to form the bottom wall portion of the cup. A hollow display portion of the inner housing, which houses the pod, protrudes into the interior space of the cup. The pod is held at the appropriate height in the cup to illuminate display information on the semi-opaque or translucent container sidewalls. The motion activated switch provides for a re-usable configuration.

### BRIEF DESCRIPTION OF THE DRAWINGS

FIG. 1 is an exploded side view of an embodiment of the invention.

FIG. 2 is a side view of an embodiment of the invention with display information on a sidewall thereof.

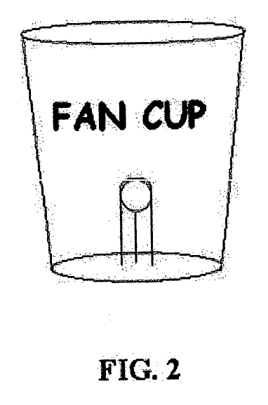

FIGS. 3A, 3B, and 3C are side views of the inner housing according to the invention, shaped as icons or models.

FIGS. 4A, 4B, 4C, 4D, 4E, and 4F schematically depict details of the display pod and its components.

FIGS. 5A, 5B, 5C, and 5D depict are exemplary container shapes.

### DESCRIPTION OF THE PREFERRED EMBODIMENTS

The invention will be better understood in connection with the following detailed description of the preferred embodiments, in which like elements in the different views are identified by the same numerals.

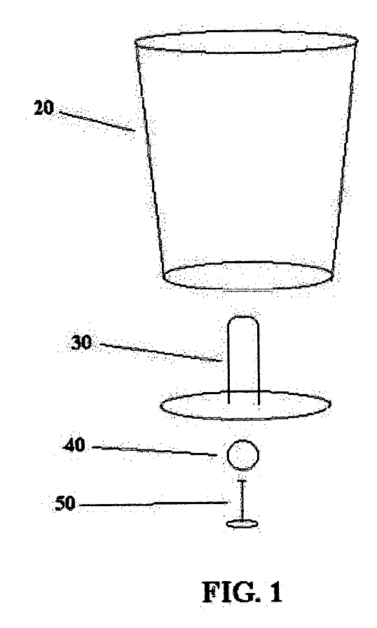

An exemplary embodiment in the form of a fan cup may be assembled as shown in FIG. 1, including sidewalls 20, inner housing 30 holding pod 40, and plunger 50 supporting the pod in the inner housing.

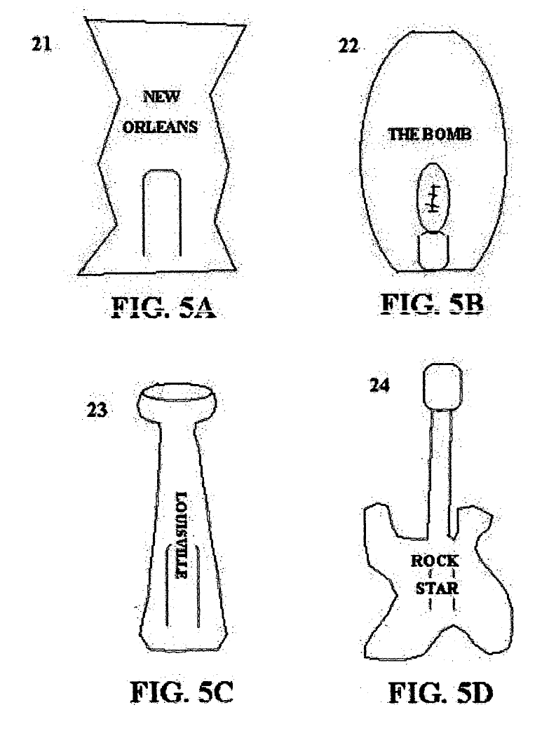

In FIG. 1, sidewalls 20 form an open ended outer housing of the container. This is an example of a standard container. This type of container would normally be manufactured with semi-opaque or translucent diffusion so that the light is more evenly distributed along the surface. This diffusion may be reduced or removed altogether. In FIG. 5B, pod 30 is shaped as a model or icon on the inside of item 22. In this instance, the display information is the model or icon itself that is meant to be most highlighted, so the side walls may be clear on this item in order to highlight the interior object.

For touring shows the item may be manufactured out of 1 mm thick PVC plastic to reduce costs and create an item that is very light. Safety is a major concern at most events so therefore it would be absolutely necessary to manufacture an item that is safe when thrown. The sidewalls may be constructed of glass in a high-end item that is used in an upscale nightclub. There may be variations in the shape color and/or texture of the sidewalls of a Fan Cup. But in the most preferred embodiments it is a drinking vessel and as such will have sidewalls in order to adequately contain any type of liquid or solid poured within its walls.

Inner housing 30, also referred to herein as the pod holder forms the physical base unit or. FIG. 1 depicts an example of a standard pod holder. The main purpose of the pod holder is to create the optimum height within the container for the LED pod 40. If the Pod Holder is too short it will not light the top half of the cup. It will also distort the light emitted and not properly light a logo or other display information on the sidewalls of the cup. The same will be true of a pod holder that is too long. In order for the cup to work properly the Pod Holder must be the correct height.

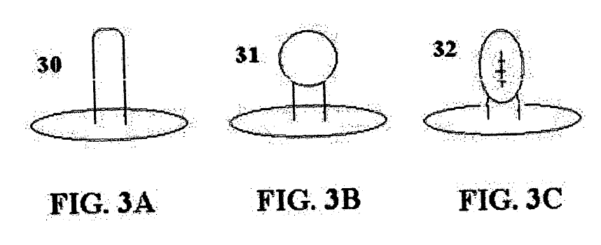

FIGS. 3A, 3B, and 3C depict different version of the pod holder 30. Pod holders 31 and 32 are shaped as icons or models, such as round sports ball 31, which could be a baseball, a basketball or the like, or a football shaped object 32. These shapes can be more complex and could include a client's logo or icon. There really is no limitation on this shape other than it must be able to securely hold the Light Pod and allow the full complement of liquid desired in the cup. This is also a very important aspect of the novelty of the Fan Cup.

The most novel aspect of the Fan Cup and what separates it clearly from all other lighted novelty drinking items is the use of a light pod. The pod typically contains at least one light emitting device, an integrated circuit, a power supply and a magnetic switch to activate the unit. The pod is a completely self-contained, waterproof, illumination source that is inserted into an inner housing at the base of the cup. This inner housing allows the pod to be positioned at the proper height inside the cup to cleanly backlight the entire exterior of the cup. By properly backlighting the logos or icons the designer can then utilize a full palette of print and LED colors to highlight the logo or icon. The designer thus has control of the illumination of the icon or logo and can deliver a very advanced novel new and innovative message sequence to the end user.

The stated purpose of the Fan Cup is to clearly illuminate logos. In order to do this you must first place the light at the correct height within the exterior of the cup. Once optimum height is achieved you now open a palette of colors both in print and LED colors that have never been an option before to any version of a patented lighted cup. Additionally the shapes as depicted in FIGS. 3A through 3C add a secondary method of delivering a complete message to the end user. For instance a band may have a tour sponsor that by contract is involved in the tour merchandising and specifically the Fan Cup. The sponsor logo or icon may be formed as the pod holder 30 in order to give the sponsor a presence on the cup but a background presence while the entertainers logo's and message are printed on the exterior sidewalls 20 of the cup. In another embodiment, the pod holder is shaped into a soccer ball for the World Cup soccer tournament. The Tournament logo would be placed on one side of the exterior sidewall of the cup and the sponsor logo on the other sidewall. The message would be accented with a pod holder shaped like item 31, a soccer ball, as a visual support to the overall message the client is trying to deliver

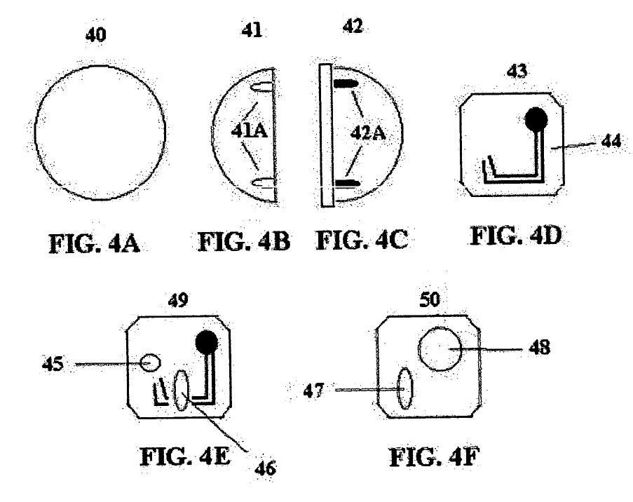

FIGS. 4A through 4F depict elements of the pod 40. In preferred embodiments, the pod is made out of clear hard plastic halves 41 and 42 which are matingly sealed with male/female inserts. Additionally the pod is sealed with an adhesive substance to insure the pod halves remain adhered. Side 44 of integrated chip (I/C) 43 demonstrates the basic wiring of the chip. The I/C functions as the main control element of the Fan Cup. The I/C can be programmed to perform myriad functions in controlling the LED. Magnetic switch 45 triggers the I/C sequence. The magnetic switch is a key element because it controls the length of time the LED sequence is allowed to run. Fan celebrations generally last approximately 15 seconds and as such the original Fan Cup will have a 15 second run time. This window of time can be manipulated in future iterations of the Fan Cup in order to meet the specific needs of the client. LEDs 46 and 47 are secured on the I/C 43. Another key function of the I/C is to secure all of the items required to make the LED function properly in one location. Future iterations of the Fan Cup may have multiple LED combination and as such the I/C will be designed to secure all of these items. Power supply 48 is also attached to I/C 43. The Fan Cup currently specifies button cell batteries such as AG3 or Cr927 as power supply to operate the LED Pod. The LED Pod is an independent, fully functioning illumination element which does not require electrical contact with other elements of the Fan Cup.

Plunger 50 serves two key functions. The first is to hold the pod at the correct height within The Pod Holder to cleanly backlight the entire cup. The second is to hold the Pod very securely in place. The Pod must be held very securely in place because this makes the triggering process of the magnetic switch much easier to achieve. If The Pod were loose inside The Pod Holder the user would have to shake or slam the Fan Cup in order to activate the illumination cycle. This would defeat the purpose of the magnetic switch and render the concept unusable. The Pod must be held very securely within The Pod Holder and it is the function of The Plunger to do this. The basic plunger has three elements. The top plate that sits directly underneath The Pod and function as a platform to secure The Pod. The Plunger arm is cut to a height necessary to completely secure the pod. Finally, there is the base plate of The Plunger. This piece completely seals The Pod inside the cup. The base piece is either sealed to the base of the cup with an adhesive or screws.

The foregoing detailed description of the preferred embodiments is not intended to be limiting of the invention, which is defined by the following claims.

1. A display comprising:
an outer housing at least partly transparent to visible light;
an inner housing at least partly transparent to visible light inserted into said outer housing;
a light emitting display pod disposed in said inner housing including a power supply and a motion activated switch;
a plunger inserted into said inner housing securely supporting the display pod in the inner housing;
wherein at least one of the pod, the outer housing and the inner housing bears display information and wherein the display pod is not in electrical contact with the plunger, inner housing or outer housing.

2. The display of claim 1, wherein said outer housing is in the form of a cup including an open end and semi-opaque or translucent sidewalls bearing display information.

3. The display of claim 1, wherein the motion activated switch in the display pod is a magnetic switch operatively connected to an integrated circuit for keeping the display pod lit for a period of time.

4. The display of claim 1, wherein the outer housing is glass or plastic.

5. The display of claim 1, wherein the display pod is shaped to form a model.

6. A display cup comprising:
at least partially transparent container sidewalls defining an open top end for access to an interior space of the cup;
an inner housing mating with said sidewalls and including a bottom wall portion forming a bottom wall of the cup and a hollow display portion protruding into the interior space of the cup;
a display pod in the inner housing including a power source, a light emitting element, a motion activated switch to turn on the light emitting element and an integrated circuit to keep the light emitting
a plunger securely supporting the pod in the inner housing and completely closing the inner housing when the cup is assembled.
